(19) United States
(12) Patent Application Publication
(10) Pub. No.: US 2011/0050737 A1
(43) Pub. Date: Mar. 3, 2011

(54) METHOD FOR ADJUSTING CHROMATICITY OF LIQUID CRYSTAL DISPLAY

(75) Inventors: Dong-Xian Yu, Nantou County (TW); Wen-Tsung Huang, Tainan City (TW)

(73) Assignee: HANNSTAR DISPLAY CORPORATION, Taipei County (TW)

(21) Appl. No.: 12/724,431

(22) Filed: Mar. 16, 2010

(30) Foreign Application Priority Data
Aug. 27, 2009 (TW) 98128905

(51) Int. Cl. G09G 5/10

(52) U.S. Cl. 345/690; 345/88

(57) ABSTRACT

A method for adjusting a chromaticity of a liquid crystal display (LCD) is provided. Firstly, a light-on-test is performed to a plurality of backlight modules according to a standard gamma curve of a liquid crystal panel to obtain a color space of a plurality of LCDs formed by the backlight modules and the liquid crystal panel. The color space has a plurality of chromaticity coordinate values for representing chromaticities of the LCDs. The standard gamma curve is a relation curve of brightness corresponding to different gamma voltages inputted to the liquid crystal panel. Next, the color space is divided into a predetermined chromaticity area and a plurality of adjusting chromaticity areas according to a standard chromaticity range. Finally, a plurality of gamma voltage adjusting values corresponding to the adjusting chromaticity areas is obtained according to the relative position relationship between the adjusting chromaticity areas and the predetermined chromaticity area.

### CROSS-REFERENCE TO RELATED APPLICATION

This application claims the priority benefit of Taiwan application serial no. 98128905, filed Aug. 27, 2009. The entirety of the above-mentioned patent application is hereby incorporated by reference herein and made a part of specification.

### BACKGROUND OF THE INVENTION

1. Field of the Invention

The present invention relates to a chromaticity adjusting technique of a display device, more particularly, to a method for adjusting a chromaticity of a liquid crystal display (LCD).

2. Description of Related Art

Theoretically, when a light-emitting diode (LED) is lighted up, an actual chromaticity thereof is the same or closed to an ideal chromaticity thereof. However, due to inevitable errors generated during a fabrication process of the LED, the actual chromaticity of the LED is deviated from the ideal chromaticity thereof, as that shown in FIG. 1. FIG. 1 is a commission international de l'eclairage (CIE) chromaticity diagram of a plurality of conventional liquid crystal displays (LCDs) respectively having a white color LED backlight module, wherein the chromaticity of each LCD is represented by chromaticity coordinate values. According to FIG. 1, it is known that the actual chromaticities of the LCDs having the LEDs with the same chromaticity specification are different.

Moreover, the chromaticity coordinate values approximately have a zonal distribution. Since a chromaticity difference at two ends of the zonal distribution is relatively great, a designer may define an ideal chromaticity area A according to an actual product demand to select the LEDs conforming to the product specification. Regarding a LCD having a color filter, when the chromaticity coordinate values of the actual chromaticity of the LCD fall within the ideal chromaticity area A, it is considered to be conformed to the standard of the chromaticity specification. Conversely, when the chromaticity coordinate values fall within chromaticity areas B and C outside the ideal chromaticity area A, it is considered to be not conformed to the standard of the chromaticity specification.

According to the above description, if the LEDs of a whole production lot are purchased to use as the light sources of the LCDs, color filters of other two specifications have to be designed to match the LEDs that cause the chromaticity coordinate values of the LCD falling within the chromaticity areas B and C, so as to ensure a consistency of the chromaticity specification of each of the LCDs using the LEDs of such production lot. However, this would not only increase a fabrication cost of the color filter, but also increase a fabrication complexity due to different fabrication conditions of the color filters with different specifications, and even lead to a control difficulty of the fabrication process.

Another approach is to only purchase the LEDs that cause the chromaticity coordinate values of the LCD falling within the ideal chromaticity area A. Accordingly, design of the color filters matching the LEDs that cause the chromaticity coordinate values of the LCD falling within the chromaticity areas B and C is unnecessary. However, the cost for only purchasing a part of the LEDs of the whole production lot is higher than the cost for purchasing the LEDs of the whole production lot, so that a cost of the LCD is accordingly increased.

### SUMMARY OF THE INVENTION

The present invention is directed to a method for adjusting a chromaticity of a liquid crystal display (LCD), by which a usage efficiency of light-emitting diodes (LEDs) in a backlight module can be improved.

The present invention provides a method for adjusting a chromaticity of a LCD, which includes following steps. Firstly, a light-on-test is performed to a plurality of backlight modules according to a standard gamma curve of a liquid crystal panel to obtain a color space of a plurality of LCDs formed by the backlight modules and the liquid crystal panel, wherein the color space has a plurality of chromaticity coordinate values for representing chromaticities of the LCDs, and the standard gamma curve is a relation curve of brightness corresponding to different gamma voltages inputted to the liquid crystal panel. Next, the color space is divided into a predetermined chromaticity area and a plurality of adjusting chromaticity areas according to a standard chromaticity range. Thereafter, a plurality of gamma voltage adjusting values corresponding to the adjusting chromaticity areas is obtained according to a relative position relationship between the adjusting chromaticity areas and the predetermined chromaticity area.

In an embodiment of the present invention, the predetermined chromaticity area is located in the standard chromaticity range, and the adjusting chromaticity areas are located outside the standard chromaticity range. In an embodiment, the predetermined chromaticity area is located between the adjusting chromaticity areas.

In an embodiment of the present invention, the method for adjusting the chromaticity of the LCD further includes adjusting the standard gamma curve according to the chromaticity coordinate values of the LCD, so that the chromaticity coordinate values of chromaticities of the adjusted LCDs fall in the predetermined chromaticity area.

In an embodiment of the present invention, the color space is a commission international de l'eclairage (CIE) chromaticity diagram, and the CIE chromaticity diagram has a first axis and a second axis.

In an embodiment of the present invention, coordinate values of the standard chromaticity range on the first axis are between a first lower limit and a first upper limit, and coordinate values thereof on the second axis are between a second lower limit and a second upper limit. Moreover, coordinate values of one of the adjusting chromaticity areas on the first axis are less than the first lower limit, and coordinate values of another one of the adjusting chromaticity areas on the first axis are greater than the first upper limit.

In an embodiment of the present invention, the backlight modules corresponding to the chromaticity coordinate values falling in one of the adjusting chromaticity areas are respectively a plurality of first backlight modules, and the standard gamma curve is adjusted according to the chromaticity coordinate values corresponding to the LCDs of the first backlight modules, so that coordinate values of the chromaticities of the adjusted LCDs on the first axis are increased to be between the first lower limit and the first upper limit.

In an embodiment of the present invention, coordinate values of part regions of one of the adjusting chromaticity areas on the second axis are less than the second lower limit. In an embodiment, the backlight modules corresponding to the chromaticity coordinate values falling in part regions of one of the adjusting chromaticity areas adjust the standard gamma curve according to the chromaticity coordinate values corresponding to the LCDs of the backlight modules, so that coordinate values of the chromaticities of the adjusted LCDs on the first axis are between the first lower limit and the first upper limit, and coordinate values thereof on the second axis are between the second lower limit and the second upper limit.

In an embodiment of the present invention, the backlight modules corresponding to the chromaticity coordinate values falling in the other one of the adjusting chromaticity areas are respectively a plurality of second backlight modules, and the standard gamma curve is adjusted according to the chromaticity coordinate values corresponding to the LCDs of the second backlight modules, so that coordinate values of the chromaticities of the adjusted LCDs on the first axis are decreased to be between the first lower limit and the first upper limit.

In an embodiment of the present invention, coordinate values of part regions of the other one of the adjusting chromaticity areas on the second axis are greater than the second upper limit. In an embodiment, the backlight modules corresponding to the chromaticity coordinate values falling in part regions of the other one of the adjusting chromaticity areas adjust the standard gamma curve according to the chromaticity coordinate values corresponding to the LCDs of the backlight modules, so that coordinate values of the chromaticities of the adjusted LCDs on the first axis are between the first lower limit and the first upper limit, and coordinate values thereof on the second axis are between the second lower limit and the second upper limit.

In an embodiment of the present invention, the first axis is a horizontal axis, and the second axis is a vertical axis.

In an embodiment of the present invention, the liquid crystal panel includes an active device array substrate, a color filter, and a liquid crystal layer. The color filter is opposite to the active device array substrate, and the liquid crystal layer is disposed between the active device array substrate and the color filter.

In an embodiment of the present invention, each of the backlight modules includes a plurality of light-emitting diodes (LEDs).

According to the above descriptions, the present invention provides a method for adjusting a chromaticity of a LCD, and by adjusting the gamma voltage curve of the liquid crystal panel, the chromaticities of the LCDs using the backlight modules with different chromaticities and the corresponding liquid display panel can be conformed to a chromaticity specification, so that a usage efficiency of the LEDs in the backlight modules is improved.

In order to make the aforementioned and other features and advantages of the present invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a commission international de l'eclairage (CIE) chromaticity diagram of a plurality of conventional liquid crystal displays (LCDs) respectively having a white color light-emitting diode (LED) backlight module.

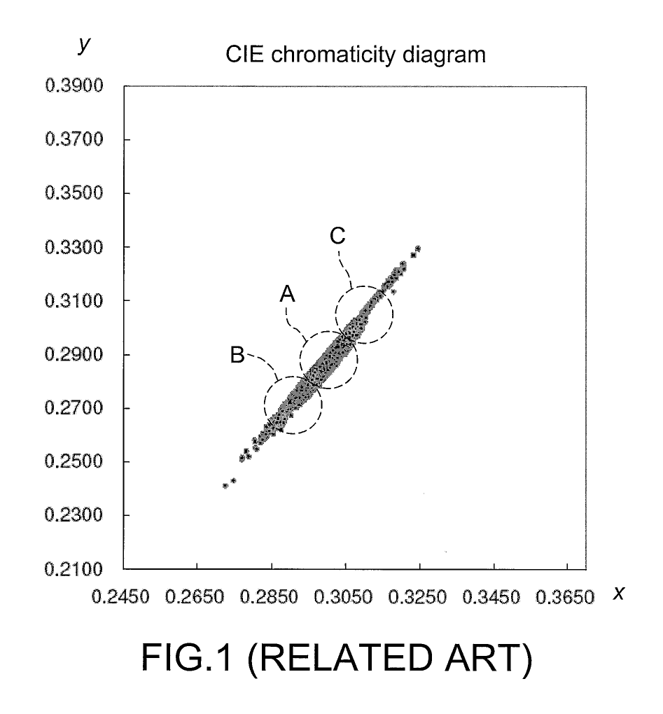

FIG. 2 is a flowchart illustrating a method for adjusting a chromaticity of a LCD according to an embodiment of the present invention.

FIG. 3 is a CIE chromaticity diagram of a plurality of LCDs respectively having a white color LED backlight module.

### DESCRIPTION OF THE EMBODIMENTS

In an actual application, when an actual chromaticity of a lighted light-emitting diode (LED) is quite different to an ideal chromaticity thereof, such LED is generally abandoned, so that a usage efficiency of the LED is reduced. Accordingly, the present invention provides a method for adjusting a chromaticity of a liquid crystal display (LCD), so as to improve the usage efficiency of the LED. An embodiment is provided below to describe the method for adjusting the chromaticity of the LCD, though the present invention is not limited to the provided embodiment.

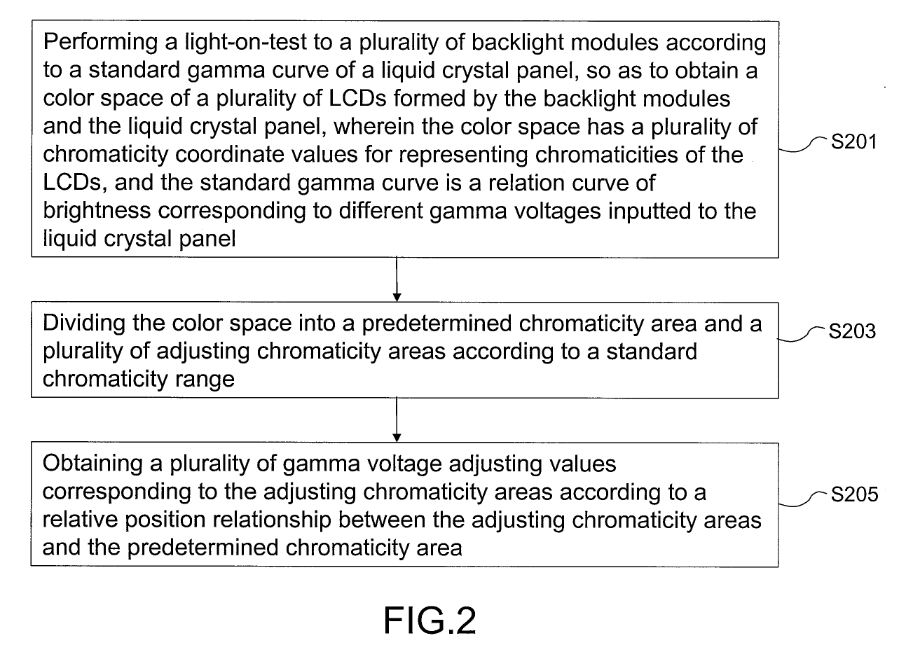

FIG. 2 is a flowchart illustrating a method for adjusting a chromaticity of a LCD according to an embodiment of the present invention. Referring to FIG. 2, first, in step S201, a light-on-test is performed to a plurality of backlight modules according to a standard gamma curve of a liquid crystal panel, so as to obtain a color space of a plurality of LCDs formed by the backlight modules and the liquid crystal panel.

The standard gamma curve of the present embodiment is a relation curve of brightness corresponding to different gamma voltages inputted to the liquid crystal panel, wherein the liquid crystal panel includes an active device array substrate, a color filter, and a liquid crystal layer disposed between the active device array substrate and the color filter. Moreover, each of the backlight modules includes a plurality of LEDs, and the LEDs are, for example, white color LEDs.

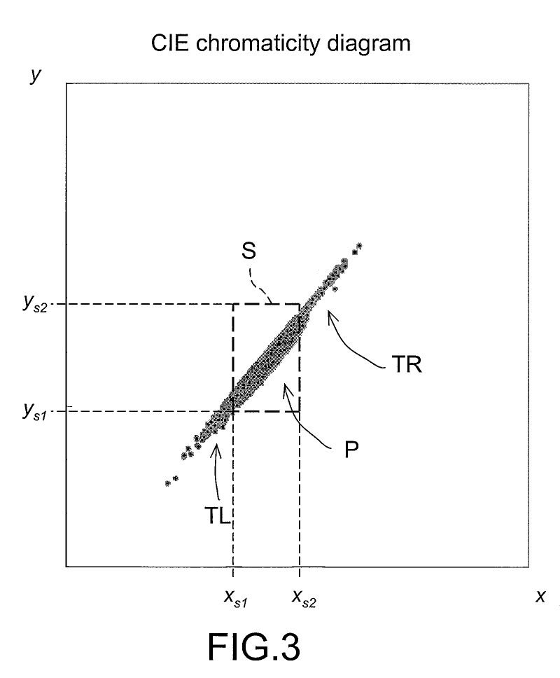

In the present embodiment, the color space is, for example, a commission international de l'eclairage (CIE) chromaticity diagram having a first axis (for example, a horizontal axis x) and a second axis (for example, a vertical axis y), as that shown in FIG. 3. Wherein, the chromaticities of the LCDs can be represented by chromaticity coordinate values in the CIE chromaticity diagram. According to FIG. 3, it is known that the chromaticity coordinate values representing the chromaticities of the LCDs approximately have a zonal distribution.

To be specific, assuming the chromaticities in a standard chromaticity range S of the CIE chromaticity diagram of FIG. 3 are all ideal chromaticities. Wherein, coordinate values of the standard chromaticity range S on the first axis x are between a first lower limit xₛ₁ and a first upper limit xₛ₂, and coordinate values of the standard chromaticity range S on the second axis y are between a second lower limit yₛ₁ and a second upper limit yₛ₂.

Next, in step S203, the color space is divided into a predetermined chromaticity area P and a plurality of adjusting chromaticity areas TR and TL according to the standard chromaticity range S. In the present embodiment, the predetermined chromaticity area P is located in the standard chromaticity range S, while the adjusting chromaticity areas TR and TL are located outside the standard chromaticity range S, and the predetermined chromaticity area P is located between the adjusting chromaticity areas TR and TL.

According to the distribution of the chromaticity coordinate values in the CIE chromaticity diagram, the predetermined chromaticity area P can be regarded as a middle part of the zonal distribution, and the adjusting chromaticity areas TR and TL can be regarded as two ends of the zonal distribution. In detail, coordinate values of the adjusting chromaticity area TL on the first axis x are less than the first lower limit xₛ₁, and coordinate values of the adjusting chromaticity area TR on the first axis x are greater than the first upper limit xₛ₂.

For simplicity's sake, the LED that cause the chromaticity coordinate values of the LCD falling in the adjusting chromaticity area TL is referred to as a first backlight module, and the LED that cause the chromaticity coordinate values of the LCD falling in the adjusting chromaticity area TR is referred to as a second backlight module.

Next, in step S205, gamma voltage adjusting values corresponding to the adjusting chromaticity areas TL and TR are obtained according to a relative position relationship between the adjusting chromaticity areas TL and TR and the predetermined chromaticity area P. A gamma curve of the LCD having the first backlight module and a gamma curve of the LCD having the second backlight module can be adjusted in a follow-up step of the present embodiment according to the gamma voltage adjusting values. It should be noticed that in the present invention, the method of obtaining the gamma voltage adjusting values is not limited. Moreover, the gamma voltage adjusting values can be fixed values, or can be parameters variable along with actual product demands.

According to FIG. 3, it is known that the adjusting chromaticity area TL is located at a left side of the predetermined chromaticity area P. Therefore, the gamma curve of the LCD having the first backlight module can be adjusted according to the corresponding chromaticity coordinate values and the suitable gamma voltage adjusting value, so that the adjusting chromaticity area TL (an area where the chromaticity coordinate values of the chromaticity of the LCD having the first backlight module are located) is shifted rightwards to be closed to the standard chromaticity range S or fall in the standard chromaticity range S. In detail, a coordinate value of the adjusted chromaticity of the LCD having the first backlight module on the first axis x is increased from a value less than the first lower limit xₛ₁ to a value between the first lower limit xₛ₁ and the first upper limit xₛ₂. Therefore, an actual chromaticity of the adjusted LCD is conformed to the ideal chromaticity or closed to the ideal chromaticity.

In an exemplary embodiment, the coordinates values of the chromaticities of the LCDs having the first backlight modules that are in the adjusting chromaticity area TL and less than the second lower limit yₛ₁ are further adjusted, so that the chromaticities of the adjusted LCDs can be conformed to the ideal chromaticity. In detail, this part of the adjusting chromaticity area TL is shifted upper-rightwards to enter into the standard chromaticity range S. Namely, the coordinate values of this part of the adjusting chromaticity area TL on the first axis x are increased from values less than the first lower limit xₛ₁ to values between the first lower limit xₛ₁ and the first upper limit xₛ₂, and the coordinate values thereof on the second axis y are increased from values less than the second lower limit yₛ₁ to values between the second lower limit yₛ₁ and the second upper limit yₛ₂.

Similarly, the method of adjusting the gamma curve of the LCD having the first backlight module can also be used to adjust the gamma curve of the LCD having the second backlight module. Since the adjusting chromaticity area TR is located at a right side of the predetermined chromaticity area P, the gamma curve of the LCD having the second backlight module can be adjusted according to the corresponding chromaticity coordinate values and the suitable gamma voltage adjusting value, so that the adjusting chromaticity area TR (an area where the chromaticity coordinate values of the chromaticity of the LCD having the second backlight module are located) is shifted leftwards to be closed to the standard chromaticity range S or fall in the standard chromaticity range S. In detail, a coordinate value of the adjusted chromaticity of the LCD having the second backlight module on the first axis x is decreased from a value greater than the first upper limit xₛ₂ to a value between the first lower limit xₛ₁ and the first upper limit xₛ₂. Now, an actual chromaticity of the adjusted LCD is conformed to the ideal chromaticity or closed to the ideal chromaticity.

However, if the coordinates values of the LCDs having the second backlight modules in the adjusting chromaticity area TR that are greater than the second upper limit yₛ₂ are adjusted to conform the chromaticities of the LCDs to the ideal chromaticity, this part of the adjusting chromaticity area TR is further shifted lower-leftwards to enter into the standard chromaticity range S. Namely, the coordinate values of this part of the adjusting chromaticity area TR on the first axis x are decreased from values greater than the first upper limit xₛ₂ to values between the first lower limit xₛ₁ and the first upper limit xₛ₂, and the coordinate values thereof on the second axis y are decreased from values greater than the second upper limit yₛ₂ to values between the second lower limit yₛ₁ and the second upper limit yₛ₂.

In an exemplary embodiment, according to the above adjusting method, the chromaticity coordinate values of the chromaticities of the adjusted LCDs approximately fall in the predetermined chromaticity area P in the standard chromaticity range S. Therefore, the actual chromaticities of the adjusted LCDs are not only conformed to the ideal chromaticity, but are also closed to each other.

It should be noticed that the above two adjusting chromaticity areas TR and TL are only used as an example, which are not used for limiting the present invention. In an actual application, more than two adjusting chromaticity areas are also applicable, by which more than two adjusting chromaticity areas probably have to be partitioned outside the standard chromaticity range S according to a special design consideration, so as to achieve a better chromaticity performance of the adjusted LCDs. Alternatively, the designer probably uses a different type of the chromaticity diagram to serve as the color space of the LCDs, so that the distribution of the chromaticity coordinate values representing the chromaticities of the LCDs has a different presentation, and accordingly a quantity and positions of the adjusting chromaticity areas are influenced. In conclusion, the adjusting chromaticity areas (for example, TR and TL) are required to be located outside the standard chromaticity range S, and the quantity and the distribution thereof are not limited.

As described above, according to the method for adjusting the chromaticity of the LCD, the actual chromaticities of the LCDs that are originally not conformed to the ideal chromaticity can be adjusted to close to the ideal chromaticity or even conform to the ideal chromaticity. Moreover, according to the aforementioned adjusting method, the chromaticity performances of the LCDs having the LEDs of the same production lot are very close, and the chromaticities of the LCDs are conformed to the required ideal chromaticity, so that the LEDs of such production lot have a high usage efficiency. Therefore, a problem of a conventional technique that the LEDs not conformed to the product specification have to be abandoned can be mitigated, so that a situation of only purchasing the LEDs of a part of the chromaticity specifications in the LEDs of such production lot can be avoided, so as to reduce a purchase cost. Alternatively, a problem of additional component cost (for example, the color filter) and additional fabrication cost due to that additional models are developed to make a full use of the LEDs not conformed to the product specification can also be resolved. According to another aspect, the adjusting method of the present invention can lead to a result that the originally abandoned LEDs that are not conformed to the product specification can now be fully used, so that both of the cost-saving and environment-protecting can be achieved.

In summary, the method for adjusting the chromaticity of the LCD of the present invention avails improving a usage efficiency of the LEDs, and avails improving the chromaticity performance of the LCDs and reducing a whole cost of the LCDs.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for adjusting a chromaticity of a liquid crystal display (LCD), comprising:
performing a light-on-test to a plurality of backlight modules according to a standard gamma curve of a liquid crystal panel, so as to obtain a color space of a plurality of LCDs formed by the backlight modules and the liquid crystal panel, wherein the color space has a plurality of chromaticity coordinate values for representing chromaticities of the LCDs, and the standard gamma curve is a relation curve of brightness corresponding to different gamma voltages inputted to the liquid crystal panel;
dividing the color space into a predetermined chromaticity area and a plurality of adjusting chromaticity areas according to a standard chromaticity range; and
obtaining a plurality of gamma voltage adjusting values corresponding to the adjusting chromaticity areas according to a relative position relationship between the adjusting chromaticity areas and the predetermined chromaticity area.

2. The method for adjusting the chromaticity of the LCD as claimed in claim 1, wherein the predetermined chromaticity area is located in the standard chromaticity range, and the adjusting chromaticity areas are located outside the standard chromaticity range.

3. The method for adjusting the chromaticity of the LCD as claimed in claim 2, wherein the predetermined chromaticity area is located between the adjusting chromaticity areas.

4. The method for adjusting the chromaticity of the LCD as claimed in claim 1, further comprising:
adjusting the standard gamma curve according to the gamma voltage adjusting values.

5. The method for adjusting the chromaticity of the LCD as claimed in claim 4, wherein the chromaticity coordinate values of chromaticities of the adjusted LCDs fall in the predetermined chromaticity area.

6. The method for adjusting the chromaticity of the LCD as claimed in claim 1, wherein the color space is a commission international de l'eclairage (CIE) chromaticity diagram, and the CIE chromaticity diagram has a first axis and a second axis.

7. The method for adjusting the chromaticity of the LCD as claimed in claim 6, wherein coordinate values of the standard chromaticity range on the first axis are between a first lower limit and a first upper limit, and coordinate values thereof on the second axis are between a second lower limit and a second upper limit, coordinate values of one of the adjusting chromaticity areas on the first axis are less than the first lower limit, and coordinate values of another one of the adjusting chromaticity areas on the first axis are greater than the first upper limit.

8. The method for adjusting the chromaticity of the LCD as claimed in claim 7, wherein the backlight modules corresponding to the chromaticity coordinate values falling in the one of the adjusting chromaticity areas are respectively a plurality of first backlight modules, and the standard gamma curve is adjusted according to the chromaticity coordinate values corresponding to the LCDs of the first backlight modules, so that coordinate values of the chromaticities of the adjusted LCDs on the first axis are increased to be between the first lower limit and the first upper limit.

9. The method for adjusting the chromaticity of the LCD as claimed in claim 7, wherein coordinate values of part regions of the one of the adjusting chromaticity areas on the second axis are less than the second lower limit.

10. The method for adjusting the chromaticity of the LCD as claimed in claim 9, wherein the backlight modules corresponding to the chromaticity coordinate values falling in part regions of the one of the adjusting chromaticity areas adjust the standard gamma curve according to the chromaticity coordinate values corresponding to the LCDs of the backlight modules, so that coordinate values of the chromaticities of the adjusted LCDs on the first axis are between the first lower limit and the first upper limit, and coordinate values thereof on the second axis are between the second lower limit and the second upper limit.

11. The method for adjusting the chromaticity of the LCD as claimed in claim 7, wherein the backlight modules corresponding to the chromaticity coordinate values falling in the other one of the adjusting chromaticity areas are respectively a plurality of second backlight modules, and the standard gamma curve is adjusted according to the chromaticity coordinate values corresponding to the LCDs of the second backlight modules, so that coordinate values of the chromaticities of the adjusted LCDs on the first axis are decreased to be between the first lower limit and the first upper limit.

12. The method for adjusting the chromaticity of the LCD as claimed in claim 7, wherein coordinate values of part regions of the other one of the adjusting chromaticity areas on the second axis are greater than the second upper limit.

13. The method for adjusting the chromaticity of the LCD as claimed in claim 12, wherein the backlight modules corresponding to the chromaticity coordinate values falling in part regions of the other one of the adjusting chromaticity areas adjust the standard gamma curve according to the chromaticity coordinate values corresponding to the LCDs of the backlight modules, so that coordinate values of the chromaticities of the adjusted LCDs on the first axis are between the first lower limit and the first upper limit, and coordinate values thereof on the second axis are between the second lower limit and the second upper limit.

14. The method for adjusting the chromaticity of the LCD as claimed in claim 6, wherein the first axis is a horizontal axis, and the second axis is a vertical axis.

15. The method for adjusting the chromaticity of the LCD as claimed in claim 1, wherein the LCD comprises:
a liquid crystal panel, comprising:
an active device array substrate;
a color filter, opposite to the active device array substrate; and
a liquid crystal layer, disposed between the active device array substrate and the color filter.

16. The method for adjusting the chromaticity of the LCD as claimed in claim 1, wherein each of the backlight modules comprises a plurality of light-emitting diodes (LEDs).
